(19) United States
(12) Patent Application Publication
(10) Pub. No.: US 2010/0245208 A1
(43) Pub. Date: Sep. 30, 2010

(54) IMAGE OUTPUT DEVICE, CONTROL METHOD AND CONTROL PROGRAM

(75) Inventor: Hiroyuki Ichieda, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/729,576

(22) Filed: Mar. 23, 2010

(30) Foreign Application Priority Data
Mar. 24, 2009 (JP) 2009-072108

(51) Int. Cl. G09G 5/12

(52) U.S. Cl. 345/1.1

(57) ABSTRACT

An image output device that outputs image data to a plurality of display devices connected to the image output device includes: a screen generating portion that generates image data on a plurality of virtual screens; a detecting portion that detects the connection states of the display devices; a display control portion that displays the virtual screens generated by the screen generating portion on a display portion of the image output device; an information input portion that receives the input of relationship information for associating the display devices detected by the detecting portion and the virtual screens; and an associating portion that associates the display devices detected by the detecting portion and the virtual screens on the basis of the relationship information and outputs the image data on the virtual screens to the corresponding display devices.

### BACKGROUND

1. Technical Field

The present invention relates to image output devices, control methods and control programs.

2. Related Art

Hitherto, there has been known an image display system including a display device that displays a screen based on input image data and an image output device that has a display portion displaying a screen based on image data and outputs image data to the display device. (Refer to JP-A-2007-240813, for example).

The image display system disclosed in JP-A-2007-240813 includes four projectors (which may be the display devices) and a computer (which may be the image output device) that has a display (which may be the display portion). The computer generates a plurality of virtual screens and outputs the image data on the generated virtual screens to the projectors. The projectors display the screens based on the input image data.

However, since the computer disclosed in JP-A-2007-240813 associates the virtual screens and the projectors in advance, it is difficult for a user of the image display system to select the projectors to output the image data on the virtual screens.

### SUMMARY

An advantage of some aspects of the invention is to provide an image output device, control method and control program easily allowing requested display devices to display requested screens.

According to an aspect of the invention, there is provided an image output device that outputs image data to display devices having a display portion to display a screen based on image data and displaying a screen based on image data to be displayed, the image output device including a screen generating portion that generates image data on a plurality of virtual screens, a detecting portion that detects the connection states of the display devices, a display control portion that displays the virtual screens generated by the screen generating portion on a display portion of the image output device, an information input portion that receives the input of relationship information for associating the display devices detected by the detecting portion and the virtual screens, and an associating portion that associates the display devices detected by the detecting portion and the virtual screens on the basis of the relationship information and outputs the image data on the virtual screens to the corresponding display devices.

With the configuration of the aspect of the invention, a user of the image output device can identify the virtual screens by looking at the display portion. A user can identify the virtual screens by looking at the display portion and can further input the relationship information through the information input portion so as to easily display the requested screens on the requested display devices.

The load on the image display device can be reduced, compared with the case where the amount of image data on the virtual screens to be displayed on the display portion is equal to the amount of image data to be output to the display devices.

Since one virtual screen can be displayed on the entire display area of the display portion, the convenience to users can be improved.

Here, a user can identify the virtual screen displayed on the entire display area of the display portion by looking at the entire display area of the display portion, without looking at the virtual screens displayed in a reduced size on a part of the display area of the display portion.

Thus, according to the aspect of the invention, among the virtual screens displayed in a reduced size on a part of the display area of the display portion, the display control portion converts the image data on the virtual screen displayed on the entire display area of the display portion to image data having a predetermined pattern (such as image data in which all pixels are black). Therefore, the load on the image display devices can be reduced.

After the display devices connected to the image output device and the virtual screens are associated by the associating portion, a user may not be required to identify the virtual screens displayed in a reduced size on a part of the display area of the display portion.

According to the aspect of the invention, a user can delete the virtual screens associated with the display devices by the associating portion by inputting the deletion information through the information input portion. Thus, the load on the image display devices can further be reduced.

### BRIEF DESCRIPTION OF THE DRAWINGS

The invention will be described with reference to the accompanying drawings, wherein like numbers reference like elements.

FIG. 1 is a block diagram illustrating a schematic configuration of an image display system according to an embodiment of the invention.

FIG. 2 is a block diagram illustrating a schematic configuration of a laptop PC according to the embodiment.

FIG. 3 is a flowchart illustrating control processing in the laptop PC according to the embodiment.

FIG. 4 illustrates virtual screens displayed on a display according to the embodiment.

FIG. 5 illustrates a state where relationship information is being input in an information input portion according to the embodiment.

FIG. 6 illustrates a state where deletion information is being input in the information input portion according to the embodiment.

### DESCRIPTION OF EXEMPLARY EMBODIMENTS

With reference to drawings, there will be described an embodiment of the invention hereinafter.

### Schematic Configuration of Image Display System

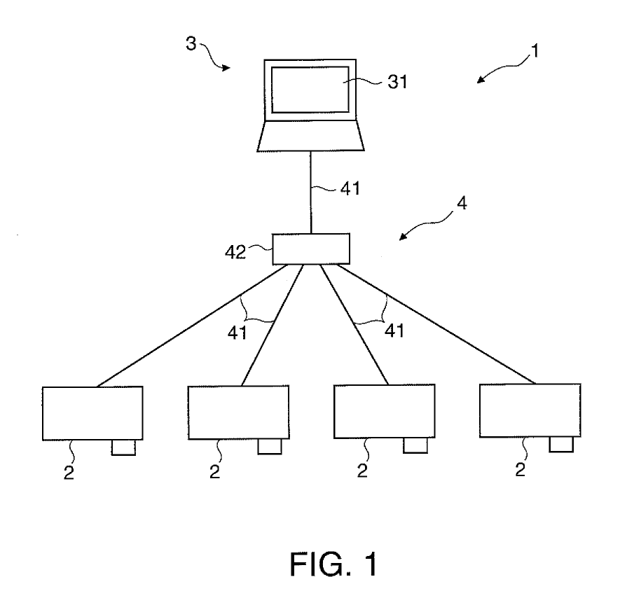

FIG. 1 is a block diagram illustrating a schematic configuration of an image display system 1 according to an embodiment of the invention.

The image display system 1 includes, as illustrated in FIG. 1, four projectors 2 that display screens based on input image data, a PC (or personal computer) 3 that has a display 31 functioning as a display portion that displays a screen based on image data and outputs image data to the projectors 2, and cables 41 and a hub 42 (which are included in a transmitting unit 4) that transmit image data output from the PC 3 to the projectors 2.

Each of the projectors 2 functioning as a display device generates image light based on image data output from the PC 3 and projects the generated image light to a projection surface (not shown) such as a screen. With the projection of the image light from the projector 2, the screen based on the image data is displayed on the projection surface.

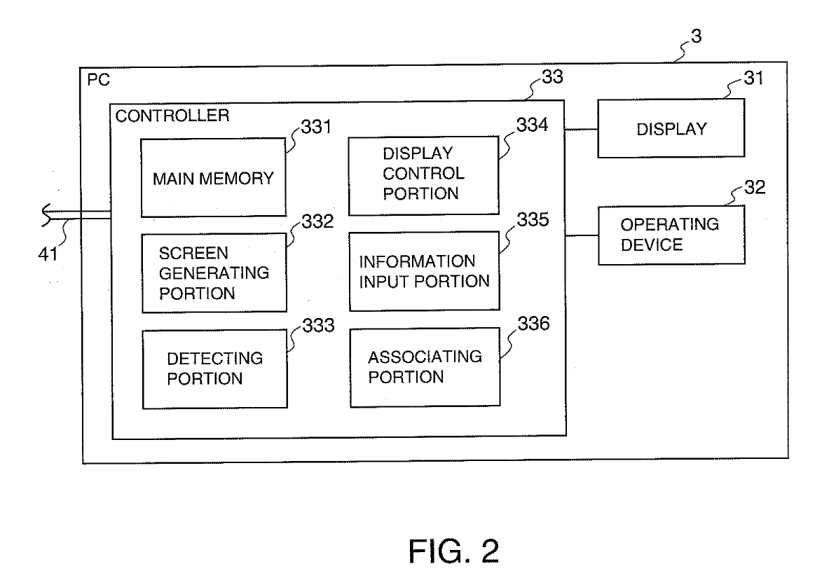

FIG. 2 is a block diagram illustrating a schematic configuration of the PC 3. Illustrating the PC 3 as a laptop PC in FIG. 2, the PC 3 may be a desktop PC or a PDA if it has the display 31.

The PC 3 functioning as the image output device roughly includes, as illustrated in FIG. 2, the display 31, an operating device 32 such as a keyboard, a tablet, a touch panel and an external mouse and a controller 33. If an external mouse is used, the operating device 32 functions as a mouse interface.

The controller 33 may include a CPU (central processing unit), for example, and controls the PC 3. The controller 33 has a main memory 331, a screen generating portion 332, a detecting portion 333, a display control portion 334, an information input portion 335, and an associating portion 336.

The main memory 331 stores a control program, which will be described later, for performing control processing in the PC 3 and data such as image data.

The screen generating portion 332 generates image data on a plurality of virtual screens.

The detecting portion 333 detects the projectors 2 to be connected to the PC 3.

The display control portion 334 causes the display 31 to display the virtual screens generated by the screen generating portion 332.

The information input portion 335 receives the input of the relationship information for associating between the projectors 2 detected by the detecting portion 333, and the corresponding virtual screens.

The associating portion 336 associates the projectors 2 detected by the detecting portion 333 and the corresponding virtual screens on the basis of the relationship information and outputs the image data on the virtual screens to the projectors 2.

### Control Processing in PC

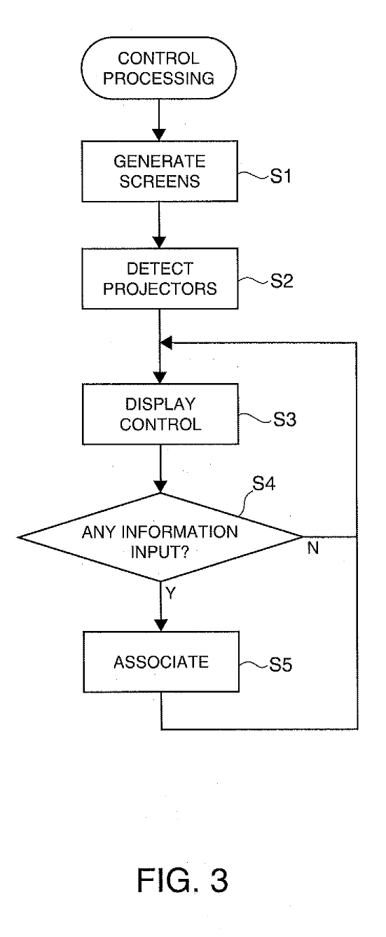

Next, there will be described control processing in the PC 3 with reference to FIGS. 3 to 6.

FIG. 3 is a flowchart illustrating control processing in the PC 3.

When a user of the image display system 1 executes control processing in the PC 3 through the operating device 32, the PC 3 executes the control program stored in the main memory 331.

If the control program is executed in the PC 3, the screen generating portion 332 generates image data on a plurality of virtual screens, as illustrated in FIG. 3, (S1: screen generating step). According to this embodiment, the number of virtual screens is input through the operating device 32 by a user in executing the control processing. It is assumed that the screen generating portion 332 generates four virtual screens in the following description.

If the virtual screens are generated in screen generating step S1, the detecting portion 333 detects the projectors 2 to be connected to the PC 3 (S2: detecting step). According to this embodiment, the detecting portion 333 gives identification numbers to the projectors 2 connected to the PC 3 in the order of detection. It is assumed here that identification numbers PJ1 to PJ4 are given to the projectors 2.

If the projectors 2 are detected in detecting step S2, the display control portion 334 causes the display 31 to display the virtual screens generated by the screen generating portion 332 (S3: display controlling step).

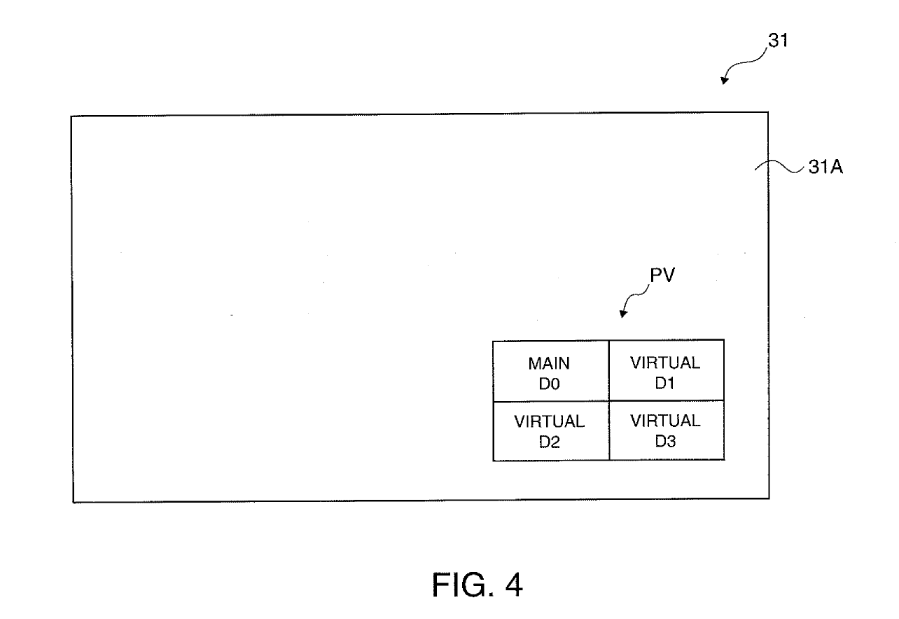

FIG. 4 illustrates virtual screens displayed on the display 31.

When, on the PC 3, the number, 3, for example, is selected as the number of virtual displays and a special application is started, preview screens as illustrated in FIG. 4 are displayed. The preview screens may be displayed on a display area 31A when the PC and the projectors are not connected. The main preview screen (which is the main screen D0 here) on the display area (which is the display area 31A here) that is already viewed by a user is preferably a black screen or a blue screen (or has a blue background).

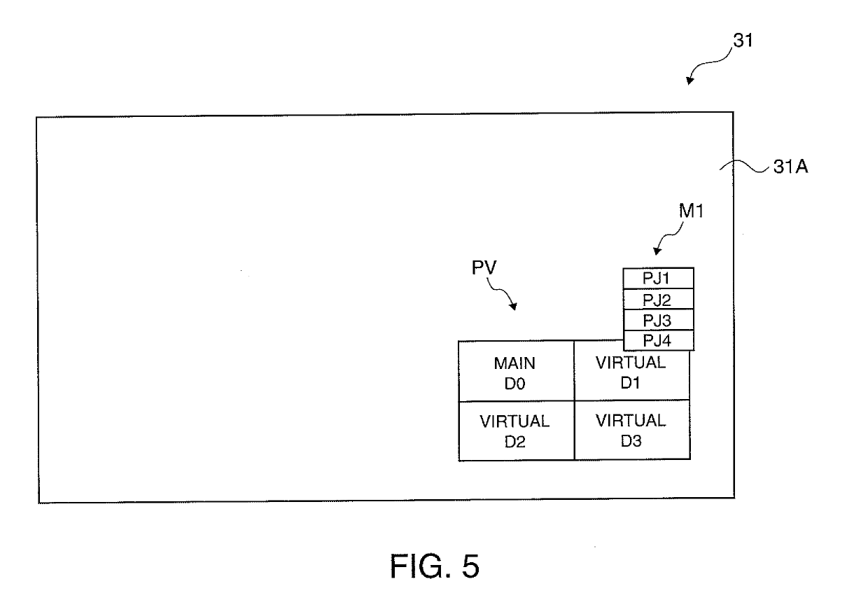

After that, if the PC 3 and the four projectors are connected, the application operating on the PC detects the number of connected projectors and updates and displays a connection list (as in FIG. 5).

If a user selects one preview screen (such as a virtual screen D1) by a mouse operation, a list of currently connectable projectors is displayed as a menu M1. A user can select a projector that he or she requests to connect from the list on the menu M1. Preferably, the already connected projectors on the connection list are displayed in gray so as to temporarily inhibit selecting as a projector to connect.

If a PJ1 is selected from the connection list (M1), the screen data on the virtual D1 may be acquired from the special application and be transferred to the PJ1, and the PJ1 can project the screen.

In this way, since virtual screens are displayed on preview screens, the operating states on the operating application can be checked on the virtual displays even when the virtual displays and the projectors are not connected. Thus, higher user operability can be attained.

Moreover, the projectors to connect can be selected on the preview screens, a user can intuitively perform the connection operation, and even a user who is not familiar with the operation can easily perform the connection operation.

The display control portion 334 displays one virtual screen of the virtual screens generated by the screen generating portion 332 on the entire display area 31A of the display 31, as illustrated in FIG. 4. The display control portion 334 further displays the preview screens PV at a lower right part of the display area 31A.

The preview screens PV are virtual screens having a reduced size and being displayed on a part of the display area 31A. In FIG. 4, the virtual screen displayed on the entire display area 31A is illustrated as a main screen D0, and the other three virtual screens are illustrated as virtual screen D1, D2 and D3.

The display control portion 334 converts the image data on the main screen D0 of the preview screens PV to image data having a predetermined pattern in which all pixels are black. Thus, the amount of image data on the virtual screens D1 to D3 can be reduced, compared with the amounts of image data to be output to the projectors 2. The predetermined pattern may have a logo or a blue background.

In order to reduce the amount of the image data, the resolution of the image data may be reduced, or the speed of update on the image data may be reduced.

The display control portion 334 further deletes the virtual screens D0 to D3 on the basis of deletion information stored in the main memory 331. The deletion information is stored in the main memory 331 in information input step S4, which will be described later.

If, in display controlling step S3, the preview screens PV are displayed on the display area 31A, the information input portion 335 receives the input of the relationship information for associating between the projectors 2 detected by the detecting portion 333 and the virtual screens D0 to D3 and to input deletion information for deleting the virtual screens D0 to D3 associated with the projectors 2 from the display 31 in associating step S5, which will be described later, (S4: information input step). The input relationship information and deletion information are stored in the main memory 331.

If the relationship information is input in information input step S4, the associating portion 336 associates the projectors 2 detected by the detecting portion 333 and the corresponding virtual screens D0 to D3 on the basis of the relationship information stored in the main memory 331 and outputs the image data on the virtual screens D0 to D3 to the corresponding projectors 2 (S5: associating step).

FIG. 5 illustrates a state where the relationship information is being input in the information input portion 335.

A user of the image display system 1 may select one of the virtual screens D0 to D3 on the preview screens PV by using the operating device 32 such as a keyboard, a tablet, a touch panel and an external mouse of the PC 3. Then, the information input portion 335 displays the menu screen M1 on the display area 31A, as illustrated in FIG. 5. In FIG. 5, it is assumed that the user selects the virtual screen D1, and the menu screen M1 is displaying a list of the identification numbers PJ1 to PJ4 given to the projectors 2.

If a user selects one of the PJ1 to PJ4 on the menu screen M1 by using the operating device 32, the associating portion 336 then associates the projector 2 having the selected identification number and the selected virtual screen D1.

For example, if the projector 2 having the identification number PJ1 is selected by a user, the associating portion 336 outputs the image data on the virtual screen D1 to the projector 2 having the identification number PJ1.

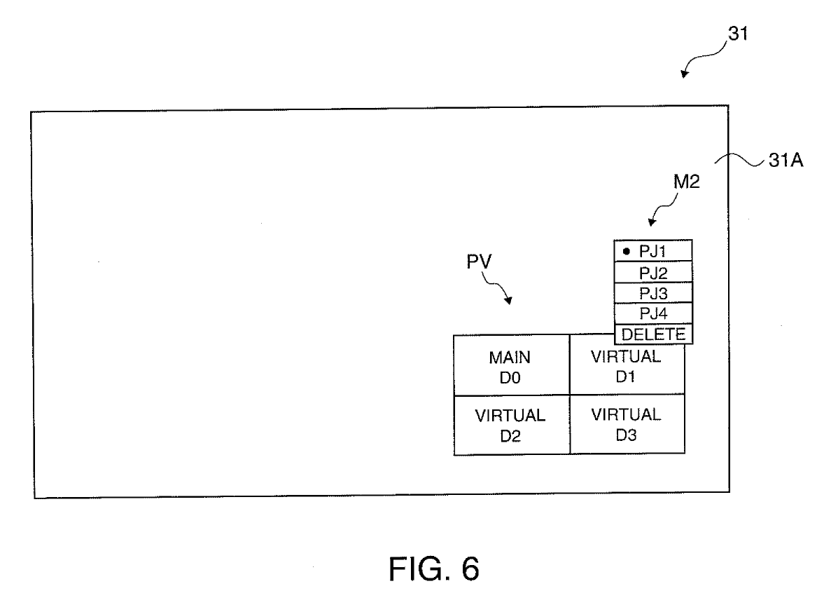

FIG. 6 illustrates a state where the deletion information is being input in the information input portion 335.

When the projector 2 having the identification number PJ1 and the virtual screen D1 are associated and if a user of the image display system 1 selects the virtual screen D1 on the corresponding preview screen PV by using the operating device 32, the information input portion 335 displays a menu screen M2 on the display area 31A, as illustrated in FIG. 6. In FIG. 6, the black dot on the menu screen M2 indicates the state where the projector 2 having the identification number PJ1 and the virtual screen D1 are associated.

In this case, the information input portion 335 displays a “Delete” column at the bottom of the menu screen M2. Thus, a user can input the deletion information by selecting the “Delete” column displayed on the menu screen M2. The input of the deletion information disables to display the virtual screen D1 that has been displayed on the preview screen PV in a reduced size on the display area 31A.

If any of the relationship information and the deletion information is not input in information input step S4 or if the association is performed in associating step S5, the PC 3 performs display controlling step S3 again.

The PC 3 according to this embodiment provides the following effects:

1. Since the PC 3 includes the display control portion 334 that displays the virtual screens D0 to D3 generated by the screen generating portion 332 on the display 31, a user of the PC 3 can identify the virtual screens D0 to D3 by looking at the display 31. Since the PC 3 includes the detecting portion 333, information input portion 335 and associating portion 336, a user can input the relationship information through the information input portion 335 so as to easily cause the requested projectors 2 to project the requested screens.

2. Since the display control portion 334 reduces the amount of image data on the virtual screens D1 to D3 to be displayed on the display 31, compared with the amount of image data to be output to the projectors 2, the load on the PC 3 can be reduced.

3. Since the display control portion 334 displays the virtual screen D0 of the virtual screens D0 to D3 on the entire display area 31A of the display 31, the convenience to users can be improved.

4. Among the virtual screens D0 to D3 displayed in a reduced size on a part of the display area 31A of the display 31, the display control portion 334 converts the image data on the virtual screen D0 displayed on the entire display area 31A of the display 31 to image data having a predetermined pattern. Thus, the load on the PC 3 can be reduced.

5. A user can delete the virtual screens D0 to D3 associated with the projectors 2 by the associating portion 336 by inputting the deletion information through the information input portion 335. Thus, the load on the PC 3 can further be reduced.

### Variations of Embodiment

The invention is not limited to the embodiment, but the variations, modifications and so on without departing from the scope and spirit of the invention are included in the invention.

For example, according to the embodiment, the display control portion 334 displays one virtual screen of the virtual screens generated by the screen generating portion 332 on the entire display area 31A of the display 31 and displays the preview screens PV at a lower right part of the display area 31A. On the other hand, the display control portion may not be required to display the one virtual screen on the entire display area of the display. In other words, the display control portion may only be required to display the virtual screens generated by the screen generating portion on the display portion.

According to the embodiment, the display control portion 334 converts the image data on the main screen D0 of the preview screens PV to image data having a predetermined pattern in which all pixels are black. Thus, the amount of image data on the virtual screens D1 to D3 can be reduced, compared with the amounts of the image data to be output to the projectors 2. On the other hand, the display control portion may convert the image data on the virtual screens to the same image data as the image data to be output to the display devices.

According to the embodiment, the information input portion 335 receives the input of deletion information for deleting the virtual screens D0 to D3 associated with the projectors 2 from the display 31 and deletes the virtual screens D0 to D3 on the basis of the deletion information stored in the main memory 331. On the other hand, the information input portion and display control portion may not be configured to be capable of deleting the virtual screens.

According to the embodiment, the information input portion 335 displays the menu screens M1 and M2 so as to prompt to input the relationship information and deletion information, for example. On the other hand, other GUIs (graphical user interfaces) such as buttons may be displayed on the display so as to prompt to input the information.

According to the embodiment, if the screen generating portion 332 generates the virtual screens D0 to D3, the detecting portion 333 detects the projectors 2 to be connected to the PC 3. On the other hand, the detecting portion may be configured to detect a display device to be connected to the image output device every time another display device is connected to the image output device.

According to the embodiment, the number of virtual screens is input by a user through the operating device 32. On the other hand, the detecting portion 333 may dynamically detect the number of the connected display devices and manage the number of virtual screens.

According to the embodiment, the transmitting unit 4 including the USB cable 41 and USB hub 42 is provided, for example. However, the transmitting unit 4 may only be required to secure a band enough to transmit image data and may include LAN (local area network) cables, a hub, a wireless LAN, a wireless USB and so on.

According to the embodiment, the projectors 2 are provided as examples of the display devices, and the PC 3 is provided as an example of the image output device. However, the display devices and the image output device may be other devices. In other words, the display device may only be required to display a screen based on the input image data, and the image output device may only be required to have a display portion that displays a screen based on image data and output the image data to a display device.

The entire disclosure of Japanese Patent Application No. 2009-72108, filed Mar. 24, 2009 is expressly incorporated by reference herein.

What is claimed is:

1. An image output device that outputs image data to a plurality of display devices connected to the image output device, the image output device comprising:
a screen generating portion that generates image data on a plurality of virtual screens;
a detecting portion that detects the connection states of the display devices;
a display control portion that displays the virtual screens generated by the screen generating portion on a display portion of the image output device;
an information input portion that receives the input of relationship information for associating the display devices detected by the detecting portion and the virtual screens; and
an associating portion that associates the display devices detected by the detecting portion and the virtual screens on the basis of the relationship information and outputs the image data on the virtual screens to the corresponding display devices.

2. The image output device according to claim 1, wherein the display control portion reduces the amount of the image data on the virtual screens to be displayed on the display portion, compared with the amount of image data to be output to the display devices.

3. The image output device according to claim 1, wherein the display control portion displays one virtual screen of the virtual screens on the entire display area of the display portion and displays the virtual screens in a reduced size on a part of the display area of the display portion.

4. The image output device according to claim 3, wherein the display control portion converts to image data having a predetermined pattern the image data on the virtual screen displayed on the entire display area of the display portion among the virtual screens displayed in a reduced size on a part of the display area of the display portion.

5. The image output device according to claim 3, wherein the display control portion deletes the virtual screens displayed in a reduced size on a part of the display area of the display portion on the basis of deletion information for deleting the virtual screens associated with the display device from the display portion.

6. A control method for an image output device that outputs image data to a plurality of display devices connected to the image output device, the method comprising:
generating image data on a plurality of virtual screens;
detecting the display devices connected to the image output device;
displaying the generated virtual screens on a display portion of the image output device;
receiving the input of relationship information for associating the detected display devices and the virtual screens; and
associating the detected display devices and the virtual screens on the basis of the relationship information and outputting the image data on the virtual screens to the corresponding display devices.

7. A control program for an image output device having a display portion that displays screens based on image data and outputs image data to at least one of display devices connected to the image output device, the program causing the image output device to perform:
generating image data on at least one virtual screen;
detecting the connected display devices;
displaying the generated virtual screens on a display portion of the image output device;
receiving the input of relationship information for associating the detected display devices and the virtual screens; and
associating the detected display devices and the virtual screens on the basis of the relationship information and outputting the image data on the virtual screens to the corresponding display devices.
